(19) United States
(12) Patent Application Publication
(10) Pub. No.: US 2017/0054811 A1
(43) Pub. Date: Feb. 23, 2017

(54) INSTALLATION HAVING AT LEAST ONE INSTALLATION COMPONENT FOR MONITORING AND/OR ADJUSTING THE INSTALLATION

(71) Applicant: Kriwan Industrie-Elektronik GmbH, Forchtenberg (DE)

(72) Inventor: Christian Ellwein, Schwabisch Hall (DE)

(21) Appl. No.: 15/240,005

(22) Filed: Aug. 18, 2016

(30) Foreign Application Priority Data
Aug. 21, 2015 (DE) 10 2015 113 885.9

(51) Int. Cl. H04L 29/08; F25B 49/02; F24F 11/00; H04L 12/66

(52) U.S. Cl. CPC H04L 67/12; H04L 12/66; F25B 49/025; F24F 11/006; F24F 2011/0071

(57) ABSTRACT

The installation according to the invention which is formed by means of a refrigerating installation, lifting gear, a ventilator or a pump installation provides for at least one electric motor and at least one installation component for monitoring and/or adjusting the electric motor, wherein the installation component has a bidirectional interface for a bidirectional communication path which is intended to be constructed in situ with a user and a unidirectional communication path in order to transmit data from the at least one installation component to a gateway.

### CROSS-REFERENCE TO RELATED APPLICATIONS

This application claims priority from German Priority Patent Application No. 10 2015 113 885.9 filed on Aug. 21, 2015, the contents of which are incorporated herein by reference.

### FIELD OF THE INVENTION

The invention relates to an installation which is formed by means of a refrigerating installation, lifting gear, a ventilator or a pump installation having at least one electric motor with at least one installation component for monitoring and/or adjusting the electric motor, wherein the installation component has a bidirectional interface for a bidirectional communication path which is intended to be constructed in situ with a user.

### BACKGROUND OF THE INVENTION

Numerous installations, such as, for example, cold storage houses and power stations, are connected to the Internet without adequate safety provisions and are thus hardly protected from attacks by hackers. With a few clicks of the mouse, such installations can be taken over and manipulated. The best possible protection of such installations is provided when the control of the installation can be carried out only in situ and there is no external connection, in particular with respect to the Internet. Although there are a large number of installations which can be operated effectively in this manner, progress is advancing in another direction, that is to say, towards increased networking of different components. The installations can thereby process a large amount of information and thereby optimise the operating method. The remote requesting of information, the maintenance and the control of an installation remotely are also features which many people appreciate. It is thus no longer a problem nowadays to control the heating in a house using a mobile phone. Even in the car, it is possible to control, for example, the auxiliary heating and the air conditioning using a mobile phone.

### SUMMARY OF THE INVENTION

An object of the invention is to improve the security of a refrigerating installation, lifting gear, a ventilator or a pumping installation having at least one electric motor and having at least one installation component for monitoring and/or adjusting the electric motor.

This object is achieved according to the invention with the features of claim 1.

The installation according to the invention which is formed by means of a refrigerating installation, lifting gear, a ventilator or a pump installation provides for at least one electric motor and at least one installation component for monitoring and/or adjusting the electric motor, wherein the installation component has a bidirectional interface for a bidirectional communication path which is intended to be constructed in situ with a user and a unidirectional communication path in order to transmit data from the at least one installation component to a gateway.

Via the unidirectional communication path, it is consequently possible to transmit all the desired data regarding the status of the installation which are stored via the gateway on a server which is accessible via the Internet and which can be requested there by authorised users. Access to the installation component via the gateway is denied as a result of the unidirectional construction of the communication path so that no data can be transmitted from the gateway to the at least one installation component.

It is naturally necessary for the installation component to nonetheless be able to be parameterised or adjusted by a user. This is carried out according to the invention via the bidirectional interface of the installation component with a bidirectional communication path which is intended to be constructed in situ with the user. A parameterisation or adjustment of the installation component is consequently possible only via the bidirectional communication path which is intended to be constructed in situ.

According to a preferred embodiment of the invention, the unidirectional communication path is constructed as a unidirectional cable or as a wireless connection. The bidirectional communication path may also be constructed as a bidirectional cable or as a wireless connection. Although a wireless connection must always potentially be considered to be non-secure, since the bidirectional communication path is constructed in situ it only has to be ensured that the region of the bidirectional communication path is a protected region, for example, company premises. The greatest possible security is provided when the bidirectional communication path is produced with a cable from the bidirectional interface to a reading and input device of the user, wherein the reading and input device has no connection to other networks.

According to another embodiment of the invention, the unidirectional communication path is also connected to the bidirectional user interface, wherein the unidirectional construction of the communication path nonetheless enables only a transmission of data from the at least one installation component to the gateway and not vice versa.

In order to further increase the security, the unidirectional communication path may be constructed between the at least one installation component and the gateway and/or the bidirectional communication path between the interface and the user on the bit transmission layer in accordance with the OSI model. OSI stands for Open System Interconnection and was developed and standardised by the ISO as a basis for the formation of communication standards. The bit transmission layer forms the lowest layer in this instance and provides mechanical, electrical and other functional auxiliary means in order to activate or deactivate physical connections, to maintain them and to transmit bits via them. These may, for example, be electrical signals, optical signals, electromagnetic waves or sound.

The at least one installation component may be a protection device for monitoring an additional installation component and/or an actuation member for adjusting an additional installation component, wherein the additional installation component may in particular be an electric motor.

### BRIEF DESCRIPTION OF THE DRAWINGS

Other embodiments of the invention are explained in greater detail below with reference to the description and the drawings, in which:

FIG. 1 is a block diagram of the installation according to the invention, and

FIG. 2 is a circuit diagram of the two communication paths.

### DETAILED DESCRIPTION OF ILLUSTRATIVE EMBODIMENTS

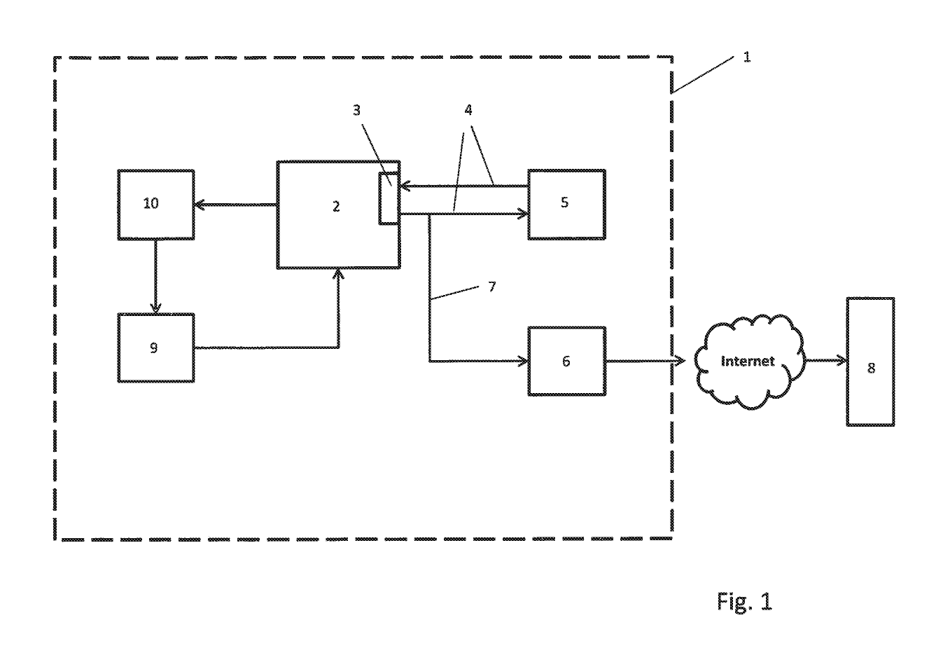

The installation 1 illustrated in FIG. 1 has an installation component 2 for monitoring and/or adjusting the installation, wherein the installation component has a bidirectional interface 3 for a bidirectional communication path 4 which is intended to be constructed in situ with a user. The user connects a reading and input device 5 to the installation component 2 via this bidirectional communication path. The bidirectional communication path 4 is, for example, constructed as a bidirectional cable which is inserted, on the one hand, at the bidirectional interface 3 and, on the other hand, at the reading and input device 5. Alternatively, however, a wireless connection is also conceivable for the bidirectional communication path 4. Preferably, the bidirectional communication path 4 is constructed between the bidirectional interface 3 and the user on the bit transmission layer in accordance with the OSI model. A particularly high safety standard is provided when the bidirectional communication path 4 is formed by a cable and the reading and input device 5 is not connected to a network at any time, in particular not during the connection to the installation component.

In order to nonetheless be able to view the operating method and/or the status of the installation 1 remotely, there is provided at least one gateway 6 which is connected to the installation 2 via a unidirectional communication path 7 in order to transfer data from the at least one installation component 2 to the gateway 6. The gateway 6 may be connected to at least one network, in particular to the Internet. As a result of the unidirectional construction of the communication path 7, only data from the installation component 2 can be transmitted to the gateway, whilst a transmission from the gateway 6 to the installation component 2 is not possible as a result of the lack of an appropriate physical connection. In principle, the unidirectional communication path 7 may also be produced as a unidirectional cable or as a wireless connection. Preferably, both the bidirectional communication path 4 and the unidirectional communication path 7 use the same interface 3 on the installation component 2.

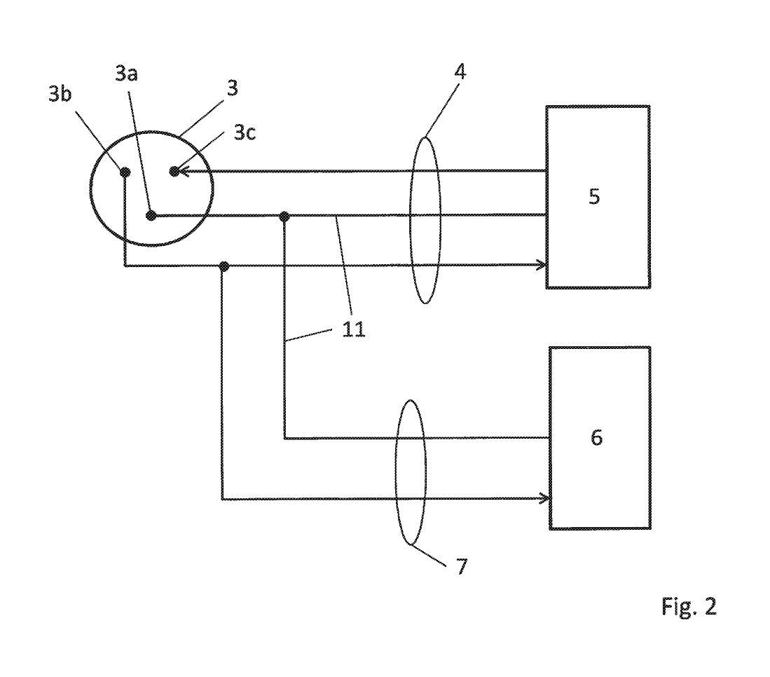

FIG. 2 is a circuit diagram of the two communication paths 4 and 7 from the bidirectional interface 3 to the reading and input device 5 or to the gateway 6. The bidirectional interface 3 is in this instance constructed with three poles, wherein a pole 3a is constructed for the earth lines 11, a pole 3b for transmitting data from the interface and a pole 3c for receiving data at the interface. Whilst in the bidirectional communication path 4 all three poles of the interface are connected to the reading and input device 5, the unidirectional communication path lacks the physical connection to the pole 3c of the interface which is responsible for receiving data. In the context of the invention, however, two separate interfaces could be provided for the two communication paths.

### EXAMPLES

In order to ensure the unidirectional nature of the communication path 7, the unidirectional communication path is also constructed between the installation component 2 and the gateway 6 on the bit transmission layer in accordance with the OSI model. The gateway 6 is, for example, connected to a server 8 which is accessible via the Internet and on which via the installation component 2 data relating to the operating method and the status of the installation 1 are stored. It is thus possible for authorised users to remotely request information relating to the installation 1 via a correspondingly encrypted connection with a high level of authentication. As a result of the unidirectional communication path 7, however, no changes to the installation are possible remotely. It is thus possible to carry out an intervention in the installation component 2 only via the unidirectional communication path 4 which is intended to be constructed in situ. Since a protection of an installation is in any case possible only when it is in a secured or protected region, this protection of the installation is also ensured when the bidirectional communication path 4 is constructed in this protected region.

The installation component for monitoring and/or adjusting the installation is, for example, a protection device which monitors an electric motor 9 which is connected to a compressor with respect to its current consumption, voltage consumption and/or (winding) temperature or the oil level of the compressor. If, for example, operation of the compressor or electric motor is determined outside a desired range, a corresponding correction can be carried out via a corresponding actuation member 10.

The desired ranges of the individual parameters which are intended to be monitored are stored in the installation component 2 and can be changed in situ by a user only via the bidirectional communication path 4 which is intended to be constructed locally, should this become required. In this manner, the installation 1 is effectively protected from manipulation via the Internet.

What is claimed is:

1. An installation which is formed by means of a refrigerating installation, lifting gear, a ventilator or a pump installation having at least one electric motor and at least one installation component for monitoring and/or adjusting the electric motor, wherein the installation component has a bidirectional interface for a bidirectional communication path which is intended to be constructed in situ with a user,
characterised in that the at least one installation component is connected to a gateway via a unidirectional communication path in order to transmit data from the at least one installation component to the gateway.

2. The installation according to claim 1, characterised in that the unidirectional communication path does not permit any transmission of data from the gateway to the at least one installation component.

3. The installation according to claim 1, characterised in that the unidirectional communication path is constructed as a unidirectional cable or as a wireless connection.

4. The installation according to claim 3, characterised in that the unidirectional communication path is connected to the bidirectional user interface.

5. The installation according to claim 1, characterised in that the bidirectional communication path is constructed as a bidirectional cable or as a wireless connection.

6. The installation according to claim 1, characterised in that the unidirectional communication path is constructed between the at least one installation component and the gateway on the bit transmission layer in accordance with the OSI model.

7. The installation according to claim 1, characterised in that the bidirectional communication path is constructed between the interface and the user on the bit transmission layer in accordance with the OSI model.

8. The installation according to claim 1, characterised in that the gateway is connected to the Internet.

9. The installation according to claim 1, characterised in that the at least one installation component is a protection device for monitoring at least one additional installation component or an actuation member for adjusting the additional installation component.
